(19) United States
(12) Patent Application Publication
(10) Pub. No.: US 2012/0033420 A1
(43) Pub. Date: Feb. 9, 2012

(54) LED LAMP HAVING BROAD AND UNIFORM LIGHT DISTRIBUTION

(76) Inventors: Sun Woong Kim, Seoul (KR); Young Wook Ko, Gyeonggi-do (KR)

(21) Appl. No.: 13/263,439

(22) PCT Filed: Apr. 7, 2010
(86) PCT No.: PCT/KR2010/002138

§ 371 Date: Oct. 7, 2011

(30) Foreign Application Priority Data
Apr. 8, 2009 (KR) 10-2009-0071607
Jul. 5, 2009 (KR) 10-2009-0039814
Jul. 5, 2009 (KR) 10-2009-0039823
Aug. 4, 2009 (KR) 10-2009-0030173
Aug. 4, 2009 (KR) 10-2009-0030179
Aug. 5, 2009 (KR) 10-2009-0040321
Nov. 12, 2009 (KR) 10-2009-0123092
Nov. 12, 2009 (KR) 10-2009-0123131
Nov. 12, 2009 (KR) 10-2009-0123137

(51) Int. Cl. F21V 1/00

(52) U.S. Cl. 362/235

(57) ABSTRACT

Provided is a light emitting diode (LED) lamp having a broad and uniform light distribution. The LED lamp having a broad and uniform light distribution includes a printed circuit board (PCB) on which a plurality of LEDs for emitting a light are mounted, a light transmitting unit that faces opposite to a side of the PCB on which the LED is mounted and forms a predetermined angle such that a light emitted from the LED is diffused in a different direction of a major light distribution corresponding to the predetermined angle, a PCB support unit that supports the PCB, and a power supply unit that supplies a power to the LED. The LED lamp according to the present invention is capable of evenly radiating a wide area, thereby replacing a conventional lamp not only in indoors such as a home or an office but also in outdoors.

### TECHNICAL FIELD

The present invention relates to a light-emitting diode (LED) lamp having broad and uniform light distribution.

### BACKGROUND ART

A light emitting diode (LED) lamp is a lamp device using an LED, which emits a light having a predetermined wavelength based on electricity supply. Due to an increased lifespan of the current LED, the LED replaces a conventional lamp and is used for advertisement signs and indoor and outdoor decorations. In particular, an LED lamp device is being actively developed to replace a fluorescent lamp that is widely used for indoor lighting. However, the LED lamp device currently developed does not show a light distribution characteristic suitable for lighting.

FIG. 1 is a view illustrating a preferable light distribution curve applicable to a lamp device. The light distribution curve, which is a curve that represents light intensity within a certain surface including a light source as a function of a direction, is generally represented by using a polar coordinate system with the light source being an origin, to indicate a characteristic of the lamp device. In case of an open fluorescent lamp, a broad and uniform light distribution is formed as shown in FIG. 1.

FIG. 2 is a perspective view illustrating a light-emitting diode (LED) lamp with an emission light path, and FIG. 3 is a view illustrating a light distribution curve of the LED lamp shown in FIG. 2.

An LED lamp 1 includes a printed circuit board (PCB) 2, which is received within a lamp box 5 and has an LED 3 being mounted thereon, and a light transmitting unit 4 through which a light, emitted from the LED 3, passes to be diffused.

In FIG. 2, an arrow indicating a direction of the light emitted from the LED 3 is shown, wherein a length of the arrow corresponds to intensity of the light emitted from the LED 3. The light is emitted from the LED 3 in a radial. A light L1 in a downward direction has a highest intensity while a light L2 in a lateral direction or in vicinity of the lamp box 5 has a relatively weak intensity due to a limited light emitting area created by an angle of a beam from the LED 3 and a space occupied by the lamp box 5.

When analyzing a light distribution of the LED 3 that is a general light source, illumination of a surface on which the light is incident is determined depending on a distance between the light source and the surface, wherein the illumination is decreased in proportion to a square of the distance therebetween. Therefore, considering a surface spaced apart from the light source at a predetermined distance, a point positioned on a line perpendicular to the light source and other points have different distances from the light source, thereby having different illumination.

As illustrated in FIG. 3, the LED lamp 1, which is a typical lamp, has a light distribution in which light intensity is high at 0 degree and illumination of an incident light is varied depending on an emission angle because the distance from the light source can be increased depending on the emission angle, thereby resulting in uneven illumination in the surface on which the light is incident. Namely, a light emitted from the LED lamp 1 inevitably has an overall light distribution that forms a sphere shape in a spatial sense, while the light intensity is the highest in a vertical direction of the LED 3.

In addition, the conventional LED lamp 1 is implemented as a plane so that the LED 3 mounted thereon is also placed horizontally along a side of the PCB 2. Therefore, the conventional LED lamp has a problem in that, even when an output light passes through the light transmitting unit 4 that includes a diffusion element, the overall light distribution has the sphere shape in a spatial sense wherein the light intensity is the highest in the vertical direction of the LED 3, as described above.

The above mentioned background arts have been possessed or acquired in the course of eliciting the invention by the inventor, and therefore, it is not conclusive that they are prior arts disclosed to the public.

### DISCLOSURE

### Technical Problem

The present invention is directed to provide a light-emitting diode (LED) lamp having a broad and uniform light distribution so that a wide area can be evenly radiated.

Also, the present invention is directed to provide a light-emitting diode (LED) lamp having a broad and uniform light distribution, which can be attached and detached to/from a conventional lamp box in an indoor environment such as a home or an office, thereby utilizing a conventional facility easily and at a low cost.

Other technical objects of the present invention will become more apparent from the following detailed description.

### Technical Solution

The principle of the present invention is to form a predetermined angle in the light transmitting unit to achieve a broad and uniform light distribution by using a characteristic that, in a flat type or tube type LED lamp, a light that passes through a light transmitting unit to be diffused has an average emission direction approximating to a normal line direction of a light transmission surface, and is to adjust an angle of a PCB on which an LED is mounted in direction toward the light transmitting surface.

In one aspect, the present invention provides a light emitting diode (LED) lamp having a broad and uniform light distribution, the LED lamp comprising: a printed circuit board (PCB) on which a plurality of LEDs for emitting a light are mounted; a light transmitting unit configured to face opposite to a side of the PCB on which the LED is mounted and configured to form a predetermined angle such that a light emitted from the LED is diffused in a different direction of a major light distribution corresponding to the predetermined angle; a PCB support unit configured to support the PCB; and a power supply unit configured to supply a power to the LED.

An angle formed between lateral sides of a cross section of the light emitting unit can be 45 degrees to 175 degrees, the PCB can form a predetermined angle such that the LEDs emit a light in different directions, and a smaller angle formed by the PCB can be 45 degrees to 180 degrees.

Here, the plurality of the LEDs mounted on different sides of the PCB can be arranged in a zigzag pattern with respect to each other, the PCB support unit can form a predetermined angle such that the PCB support unit is parallel to the PCB, the power supply unit can be positioned on a groove formed by bending the PCB support unit, and a smaller angle formed by the PCB can be 45 degrees to 180 degrees.

The PCB support unit can include a first support arm received in the light transmitting and configured to project in one direction to support the PCB and a second support arm received in the light transmitting and configured to project in the other direction to support the PCB.

In addition, one side of the light transmitting unit can be an arc, or a coupling part between lateral sides of a cross section of the light transmitting unit can have an arc shape, or a lateral side of a cross section of the light transmitting unit can have an arc shape in which a concave portion faces opposite to the PCB, wherein a cross section of the light transmitting unit can be a triangle, a trapezoid, or a polygon including a pentagon.

Also, the LED can include a blue spectrum, the light transmitting unit can include a fluorescent substance for changing a color temperature by converting a wavelength of the light emitted from the LED, and, when the PCB includes three or more sides, a brightness of the LED mounted on PCBs positioned in both lateral directions is greater than a brightness of the LED mounted on a PCB positioned in a frontal direction, wherein the PCB positioned in the frontal direction being interposed between the PCBs positioned in the both lateral directions.

The light transmitting unit can be formed in a polymer material or glass, while at least one of one side and the other side of the light transmitting unit can have a roughness, or the light transmitting unit can further include a diffusion element for diffusing the light emitted from the LED.

In addition, the light transmitting unit can further include at least one diffusion sheet coupled to at least one of one side and the other side of the light transmitting unit.

Further, the light transmitting unit can include a base surface comprising a polymer material or glass, wherein a pattern is formed on at least one of one side and the other side thereof to induce diffusion of the light emitted from the LED, and at least one diffusion sheet coupled to the at least one of the one side and the other side of the base surface.

Here, a transmission of the light transmitting unit can be 30% to 88%, a haze of the light transmitting unit can be 42% to 99.8%, and an interval between adjacent LEDs among the plurality of the LEDs can be 1 mm to 125 mm.

In addition, a length of a side of the LED can be 2 mm to 9 mm, or a diameter of the LED can be 2 mm to 25 mm.

Also, the light transmitting unit can be formed in a diffusion plate that includes a diffusion element, in an interior thereof, for diffusing the light emitted from the LED, and in this case, the diffusion element can be formed in an oxide series or in a foam-type diffusion structure including a foam-type microcell.

Further, a normal line formed by sides of the PCB and the light transmitting unit, each facing opposite to each other, can have an angle of 0 to 45 degrees, an interval between the LED and the light transmitting unit can be 5 mm to 150 mm, and when the PCB or the light transmitting unit is bent, a number of a bent portion is 1 to 4, and the LED lamp can be a flat type or a tube type.

Other aspects, features, and advantages of the present invention will become apparent from the following drawings, claims and detailed description of the invention.

### Advantageous Effects

In order to overcome disadvantages of having a distorted circular light distribution in a conventional LED lamp, an LED lamp according to the present invention is configured such that, when a PCB on which an LED is mounted is attached to an attachment surface of a lamp device or mounted as a fixture of a different form, a predetermined angle can be formed between PCBs so that, when the PCB having the above structure is positioned within the lamp device is lit up, the lamp device can have a broad and uniform illuminance, while a cross section of the light transmitting unit is configured to face the PCB, thereby achieving an effect to form a broad and uniform light distribution.

Also, in the LED lamp according to the present invention, an LED module is implemented in an attachable/detachable manner so that the LED module can be easily attached and detached to/from a conventional lamp device, thereby facilitating replacement of the LED module.

### DESCRIPTION OF DRAWINGS

FIG. 1 is a view illustrating a preferable light distribution curve applicable to a lamp device.

FIG. 2 is a perspective view illustrating a light-emitting diode (LED) lamp with an emission light path.

FIG. 3 is a view illustrating a light distribution curve of the LED lamp shown in FIG. 2.

FIG. 4 is a cross sectional view illustrating an LED lamp having a broad and uniform light distribution according to an exemplary embodiment of the present invention.

FIG. 5 is a view illustrating a light distribution curve of the LED lamp shown in FIG. 4.

FIG. 6 is a cross sectional view illustrating an LED lamp having a broad and uniform light distribution according to another exemplary embodiment of the present invention.

FIG. 7 is a plan view illustrating an LED lamp having a broad and uniform light distribution according to another exemplary embodiment of the present invention.

FIG. 8 is a cross sectional view illustrating an LED lamp having a broad and uniform light distribution according to still another exemplary embodiment of the present invention.

FIG. 9 is a cross sectional view illustrating an LED lamp having a broad and uniform light distribution according to still another exemplary embodiment of the present invention.

FIG. 10 is view illustrating an LED mounted on a PCB that is used in an LED lamp according to an exemplary embodiment of the present invention.

FIG. 11 is a view illustrating various forms of an LED lamp according to an exemplary embodiment of the present invention.

FIGS. 12 through 14 are cross sectional views of an LED lamp having a broad and uniform light distribution according to still another exemplary embodiment of the present invention.

FIGS. 15 through 17 are cross sectional views schematically illustrating an LED lamp having a broad and uniform light distribution according to still another exemplary embodiment of the present invention.

FIG. 18 is a cross sectional view illustrating an LED lamp having a broad and uniform light distribution according to an exemplary embodiment of the present invention.

FIG. 19 is a view illustrating a light distribution curve of the LED lamp shown in FIG. 18.

FIG. 20 is a view showing comparison between example experiments of the LED lamp of FIG. 18.

FIG. 21 is a cross sectional view illustrating an LED lamp having a broad and uniform light distribution according to another exemplary embodiment of the present invention.

FIG. 22 shows an exemplary embodiment of manufacturing the LED lamp shown in FIG. 21.

FIGS. 23 through 25 are various cross sectional views of an LED lamp having a broad and uniform light distribution according to an exemplary embodiment of the present invention.

FIG. 26 is an exploded perspective view illustrating an LED lamp having a broad and uniform light distribution according to an exemplary embodiment of the present invention.

FIG. 27 is a view illustrating a light distribution curve of the LED lamp FIG. 26 having the broad and uniform light distribution.

FIG. 28 is a cross sectional view illustrating an LED lamp according to an exemplary embodiment mounted within a lamp device frame.

FIG. 29 is a view illustrating a light distribution curve of the lamp device frame equipped with the LED lamp shown in FIG. 28.

FIG. 30 is a cross sectional view illustrating an LED lamp having a broad and uniform light distribution according to another exemplary embodiment of the present invention.

FIG. 31 is an exploded perspective view illustrating the LED lamp of FIG. 30.

FIG. 32 is a view illustrating a light distribution curve of the LED lamp of FIG. 30.

FIG. 33 is a view showing comparison of a photograph of a lateral side light of the LED lamp of FIG. 30 and a photograph of a lateral side light of a conventional LED lamp.

FIG. 34 is a perspective view illustrating an LED lamp according to still another exemplary embodiment of the present invention.

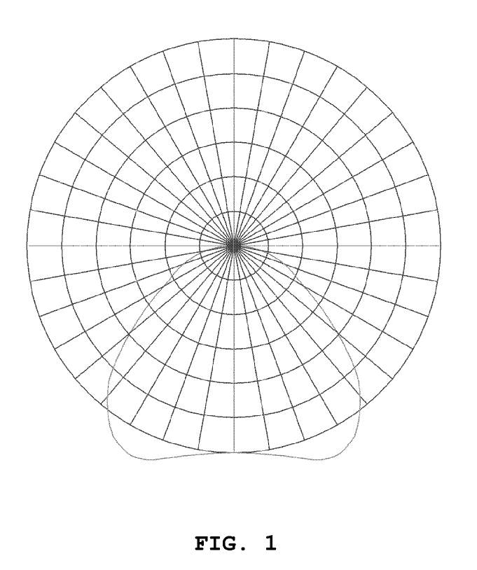

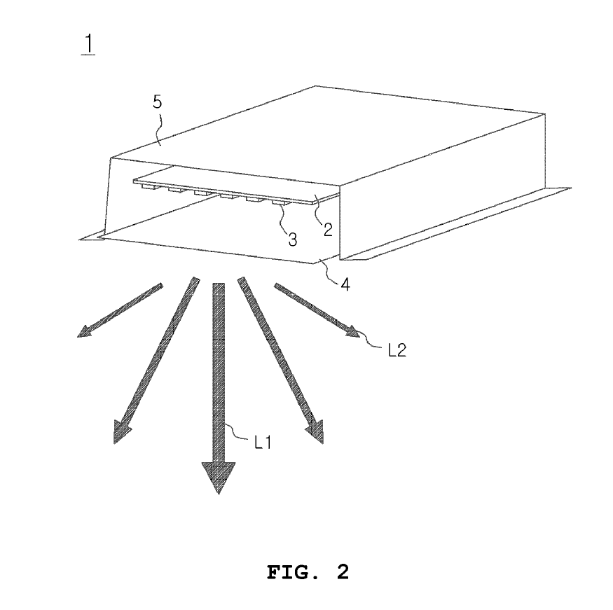

### BEST MODE

While various modifications and example embodiments can be made, only particular example embodiments will be described more fully herein with reference to the accompanying drawings. However, the present invention should not be construed as limited to only the example embodiments set forth herein but rather should be understood to cover all modifications, equivalents or alternatives falling within the scope and technical terms of the invention.

It will be understood that, although the terms first, second, etc. may be used herein to describe various elements, these elements should not be limited by these terms. These terms are only used to distinguish one element from another.

It will be understood that, when a feature or element is referred to as being “connected” or “coupled” to another feature or element, it can be directly connected or coupled to the other element or intervening elements may be present. In contrast, when a feature or element is referred to as being “directly connected” or “directly coupled” to another element, there are no intervening elements present.

The terminology used herein is for the purpose of describing particular embodiments only and is not intended to be limiting of example embodiments of the invention. It will be understood that the terms “comprises,” or “includes,” when used herein, specify the presence of stated features, integers, steps, operations, elements, components or any combinations thereof, but do not preclude the presence or addition of one or more other features, integers, steps, operations, elements, components, or any combinations thereof.

Also, the same reference numbers are used throughout the drawings to refer to the same parts regardless of drawing numbers and a repetitive explanation will be omitted. Detailed descriptions of well-known functions and structures incorporated herein may be omitted to avoid obscuring the subject matter of the present invention.

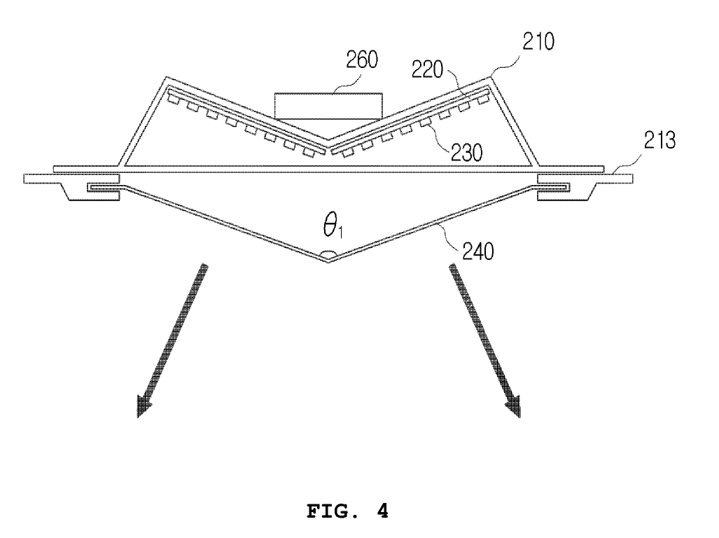

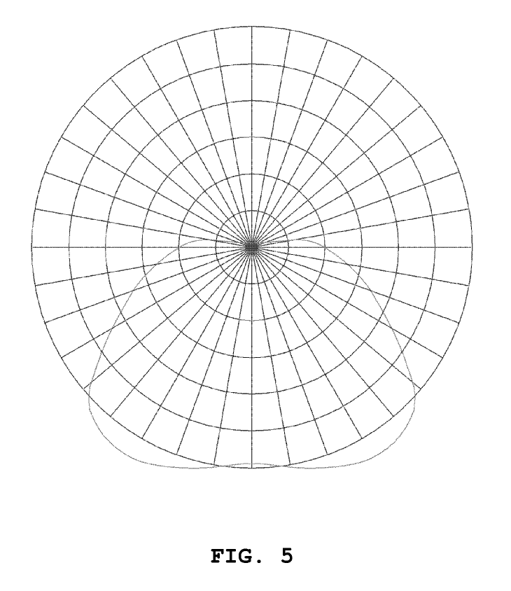

FIG. 4 is a cross sectional view illustrating a light-emitting diode (LED) lamp having a broad and uniform light distribution according to an exemplary embodiment of the present invention and FIG. 5 is a view illustrating a light distribution curve of the LED lamp shown in FIG. 4. Referring to FIG. 4, a PCB support unit 210, a light transmitting unit holder 213, a printed circuit board PCB 220, an LED 230, a light transmitting unit 240 and a power supply means 260 are shown.

This embodiment is characterized in that at least one of the PCB 220 and the light transmitting unit 240 are formed to be bent so as to have a uniform light distribution. The LED lamp according to this example embodiment is characterized in that the PCB 220, which is positioned in an interior of the LED lamp in replacement of a lamp box used for a conventional fluorescent light bulb or an incandescent light bulb, or the light transmitting unit 240 for transmitting a light is attached to form a predetermined angle or is bent or curved to have a broad and uniform light distribution. In other words, in the LED lamp according to this embodiment, the PCB 220 and/or the light transmitting unit 240 is positioned to maintain a predetermined angle so that the LED 230 can radiate a light in a different direction to have a wider light distribution.

The present invention can be applied to a flat type lamp and a tube type lamp. In other words, the present invention can be applied to the flat type lamp in which the light transmitting unit 240 is formed to be flat as a plane and applied to the tube type lamp in which the light transmitting unit 240 is formed in a tube shape such as 1-shape, V-shape, circular shape, or U-shape. Here, the flat type lamp refers to a lamp that has an overall planar shape, similar to a flat plate. For example, similar to a light lamp used for an indoor lamp at home, the flat type lamp can be a lamp in which a lamp device frame, i.e., the lamp box, is formed overall as a flat plate. Hereinafter, it is assumed that the light transmitting unit 240 is formed as a flat plate.

The PCB support unit 210 is a frame that supports the PCB 220 and each side on which the PCB 220 is positioned can form a predetermined angle such that the PCB 220 is supported at the predetermined angle described above. The PCB 220 can be coupled to the PCB support unit 210 by using a predetermined coupling unit, which can include, for example, a screw, a clip, an adhesive (including a thermal adhesive), a spring, and an adhesive pad.

The PCB 220 can include a plurality of PCBs individually coupled to each side of the PCB support unit 210 or can be a single PCB that is bent corresponding to a side of the PCB support unit 210. Hereinafter, the description will be made primarily with reference to the former case. In addition, the PCB 220 of this embodiment can be rigid or flexible.

Here, an angle formed by the PCBs 220 can be 45 degrees to 180 degrees (or 175 degrees). In other words, a smaller angle between sides of multiple PCBs 220 (for example, angle between rear sides on which the LED 230 is mounted) can be 45 degrees to 180 degrees. Due to the angle formed by the sides of the PCBs 220, a light emitted from the LED 230 can be radiated toward a lateral side of the LED lamp to form a broad and uniform light distribution.

When the angle formed by the PCB 220 is 180 degrees, the PCB 220 is a plane and, in this case, a light distribution can be formed wide due to the angle formed by the light transmitting unit 240. In other words, in this embodiment, the PCB 220 is a plane and the light transmitting unit 240 has a bent structure, which will be described below.

The light transmitting unit 240 is formed overall in a flat shape or a tube shape and can be bent to face opposite to each side of the PCB 220. The light transmitting unit 240, which is an area through which the light emitted from the LED 230 passes to be radiated outwardly, can include a diffusion element for diffusing a light. The diffusion element can be a light diffusive bead, and the light transmitting unit 240 can be formed in a plastic (polymer material) supplemented with the light diffusive bead, such as, for example, polyethylene (PE), polypropylene (PP), polystyrene (PS), polyethylene terephthalate (PET), polyester (PES), polycarbonate (PC), poly methyl methacrylate (PMMA), or styrene-acrylonitrile copolymer (SAN), or can be formed in a glass.

One side and/or the other side of the light transmitting unit 240 can be formed to have a roughness. In other words, one or more of the one side and/or the other side of the light transmitting unit 240 can be haze processed so that the light transmitting unit 240 can perform a diffusion function. In this case, the light transmitting unit 240 including or not including the diffusion element can be haze processed.

In addition, the one side and/or the other side of the light transmitting unit 240 can be coupled with a diffusion sheet. The diffusion sheet is a functional sheet for allowing the light emitted from the LED 230 to be diffused evenly and to proceed in a direction perpendicular thereto. The number of the diffusion sheet coupled to the light transmitting unit 240 is not limited and can be, for example, 1 to 3. The diffusion sheet can be coupled to both sides of the plastic or glass, which is a main component of the light transmitting unit 240 as described above, in a sandwich structure. Here, the diffusion sheet has a thickness of tens to hundreds, and the above described diffusion element is included in an external surface or inside of the diffusion sheet. According to this embodiment, when a plurality of the diffusion sheets are included in the light transmitting unit 240, a broad and uniform light distribution can be implemented as discussed above.

In this case, the light transmitting unit 240 is formed in the polymer material or glass, as described above, and can include a base surface of which at least one of one side and the other side is embossing processed and at least one diffusion sheet, which is coupled to at least one of the one side and the other side of the base surface.

In addition, the light transmitting unit 240 can be formed as a diffusion plate that includes the diffusion element on an inside thereof. The diffusion plate can be milky, have a thickness of several to tens of millimeters (mm), and include the diffusion element described above in the inside thereof. The thickness of the diffusion plate according to this embodiment can be, for example, from 0.5 mm to 15 mm.

In addition, according to this embodiment, the light transmitting unit 240 can have transmission of 30% to 88% and haze of 42% to 99.8%. Within these numerical ranges, this embodiment is characterized in that the lateral side light has a high intensity, thereby achieving a broad and uniform light distribution, as described in the above.

In addition, the diffusion element described above can be formed in oxide series or in a foam-type diffusion structure including a foam-type microcell. Here, in the former case, a material of the oxide series used for the diffusion element can be, for example, Si-based powder, TiO, TiO2, SiO, SiO2, ZnOk or ZrO2. In addition, in the latter case, instead of configuring the diffusion element as a separate organic or non-organic diffusion material, the light transmitting unit 240 is implemented in the foam-type microcell that is continuous and irregular and a light passing through the light transmitting unit 240 is diffused by the microcell.

In addition, the one side and/or the other side of the light transmitting unit 240 can be coupled with a prism sheet. The prism sheet is a sheet that is used to direct a scattered light in a particular direction. The number of the prism sheet is not also particularly limited.

In addition, the one side and/or the other side of the light transmitting unit 240 can have a pattern for inducing diffusion of the light of the LED 230. The pattern can be formed to be a regular pattern. For example, a checkerboard pattern in which a plurality of rectangles are arranged or an embossed pattern can be formed on the light transmitting unit 240 to induce the diffusion of the light.

A lateral side of a cross section of the light transmitting unit 240 can face opposite to the PCB 220. In other words, the lateral side of the cross section of the light transmitting unit 240 is a surface on which a light emitted from the PCB 220 is incident, and therefore, when this surface is formed to face opposite to the PCB 220, an effect of increasing a light distribution toward a lateral side can be achieved. The lateral side of the cross section of the light transmitting unit 240 facing opposite to the PCB 220 can be a plane or a curve. Here, facing opposite to each other indicates roughly being parallel to each other as well as strictly being parallel to each other in a mathematical sense and, according to this embodiment, normal lines of surfaces of the PCB 220 and the light transmitting unit 240 that are opposite to each other can form an angle of 0 to 45 degrees.

Depending on how many times the light transmitting unit 240 is bent, the cross section of the light transmitting unit 240 can have various shapes such as a V-shape with one low point or a W-shape with two low points. In addition, depending on whether the bent part is formed to have a rounded edge, the cross section of the light transmitting unit 240 can have a U-shape. Also, the cross section of the light transmitting unit 240 can further have a repeated-V shape in which V shape is repeated (including W shape) and a repeated-U shape.

In addition, the light transmitting unit 240 can be formed in one body of a bent material or a in a combination of different materials. For example, in the former case, the light transmitting unit 240 can be formed by bending a single planar material that is continuous. In the latter case, the light transmitting unit 240 can be formed by combining a plurality of different planar materials.

Referring to FIG. 4, the light transmitting unit 240 is coupled and fixed to the light transmitting holder 213 that is coupled to the PCB support unit 210. A lateral side of the cross section of the light transmitting unit 240 can be V-shaped. The lateral side of the cross section of the light transmitting unit 240 forms a predetermined angle₁. The lateral sides of the cross section of the light transmitting unit 240 face opposite to the PCB 220, respectively, and the angle₁ between the lateral sides can be 45 to 175 degrees.

The PCB support unit 210 can be formed in the flat type or the tube type having a predetermined angle in order for the PCB 220 to form the predetermined angle.

In addition, the light transmitting unit 240 can include a fluorescent material for controlling a color of the LED lamp. In other words, when the LED 230 includes a blue spectrum, the light transmitting unit 240 can convert a corresponding color to realize a white light or can include one or more of fluorescent substances for changing a color temperature such as, for example, red, green and yellow fluorescent substances. The fluorescent substances described above can convert a wavelength of the light emitted from the LED 230 to change the color temperature thereof and realize the white light.

Here, a separation interval between the LED 230 and the light transmitting unit 240 can be 5 mm to 150 mm. When the separation interval is less than this interval range, the LED 230 can be displayed as a point light source to the outside, and when the separation interval is greater than this interval range, a problem can be caused in that a size of the lamp device is increased.

In addition, in case of employing multiple LEDs 230, the interval between adjacent LEDs 230 can be 1 mm to 125 mm. Here, the interval between the adjacent LEDs 230 can be an interval between a center-to-center distance or an end-to-end distance between the LEDs 230. When the LED 230 has a rectangular shape, each side, i.e., a horizontal side and a vertical side, can have a length of 2 mm to 9 mm. In addition, when the LED 230 has a circular shape, a diameter (or a longitudinal axis in case of an elliptical shape) can have a length of 2 mm to 25 mm. Here, the length and the diameter of the LED 230 can be obtained by measurement, excluding a lead frame. When the LED 230 has a size described above and the above described distance with each other, it is advantageous in that the light transmitting unit 240 is not displayed as the point light source due to the above-mentioned transmission and haze of the LED 230, and can emit a uniform light to the outside.

In addition, this embodiment can further include a radiator (not shown). The radiator can be coupled to the PCB support unit 210 and/or the light transmitting unit 240 to receive heat generated in the LED 230 and to radiate the received heat to the outside. To this end, the radiator can be implemented in various radiation structures such as, for example, including a plurality of radiator pins. For example, a cross section of the radiator can have a shape of a curve, a straight line, or a combination thereof.

The radiator can be formed integrally with the PCB support unit 210 or can be provided as a separate unit. In the latter case, the radiator can be coupled to the PCB support unit 210 and the light transmitting unit 240 in a predetermined coupling manner, for example, a screw-coupling manner.

A power supply unit (PSU; including a PSU board and PSU parts) 260 is an element for supplying a current to the LED 230 and can include an AC-DC converter for supplying a direct current to the LED 230 by converting an external alternating current into a direct current. The power supply unit 260 can be implemented with various locations; for example, the power supply unit 260 can be formed in a space (groove) formed by bending the PCB support unit 210 so that space utilization and heat dissipation can be effective. In this case, the power supply unit 260 can be formed integrally with the PCB 220 or can be provided as a separate unit.

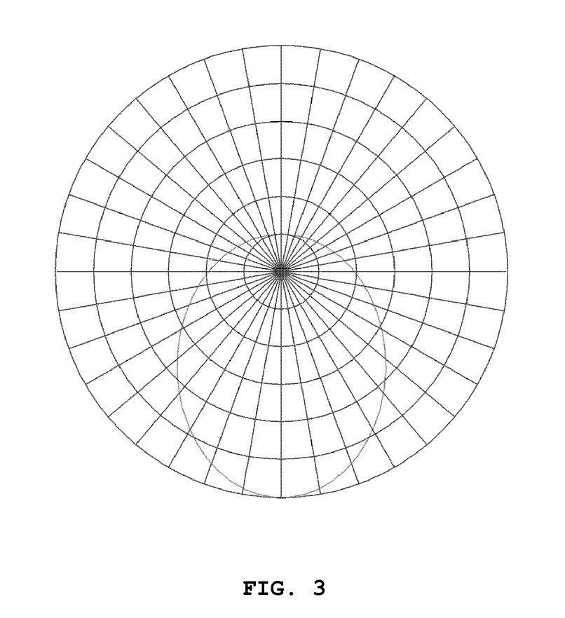

The LED lamp having a structure described above has a light distribution curve shown in FIG. 5. Referring to FIG. 5 in comparison with FIG. 3, the light distribution curve has a shape of a wide lateral spread, thereby achieving a uniform light distribution curve. The light distribution curve according to this embodiment shows a broad distribution because a light of the LED 230 has a high intensity toward a lateral side, which is a direction of a major light distribution. In addition, the light toward the lateral side is distributed in a direction above a horizon so that, when the LED lamp is installed on an indoor room ceiling, a light is emitted toward the ceiling, thereby having an indirect illumination effect.

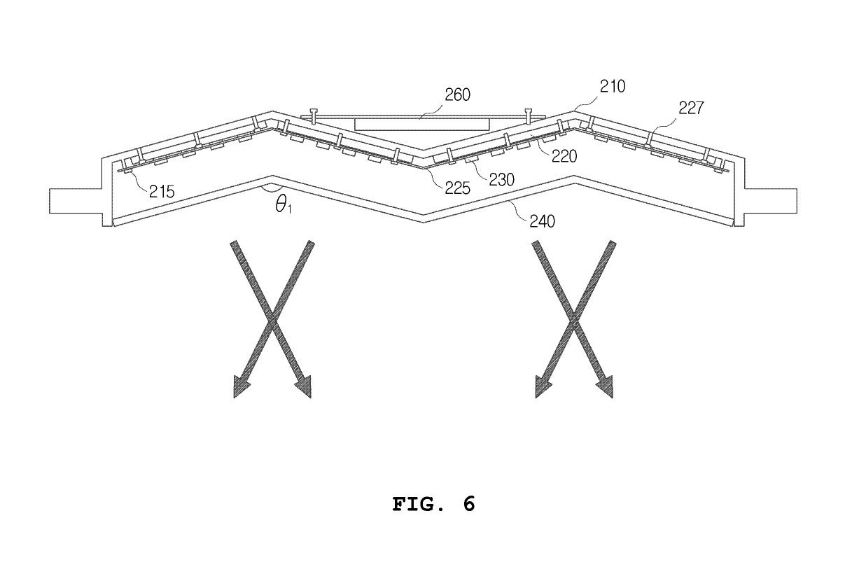

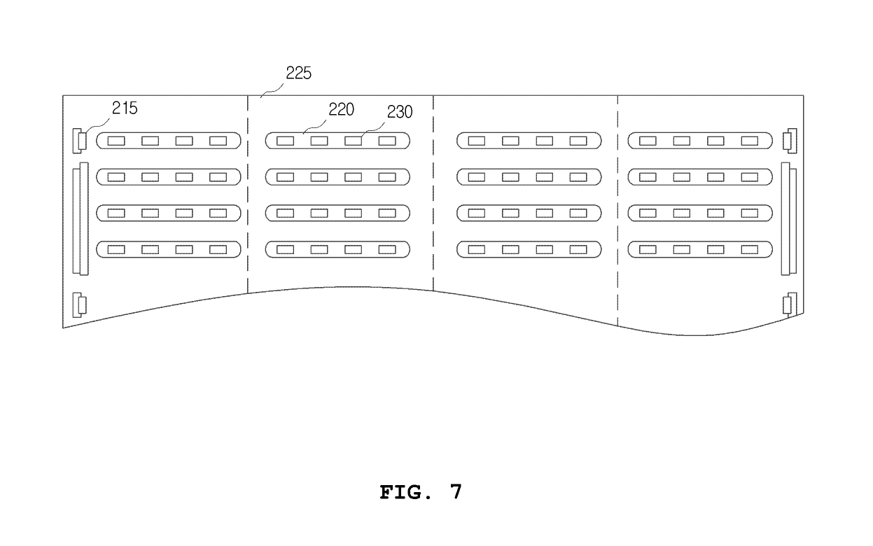

FIG. 6 is a cross sectional view illustrating an LED lamp having a broad and uniform light distribution according to another exemplary embodiment of the present invention, and FIG. 7 is a plan view of the LED lamp in FIG. 6. Referring to FIGS. 6 and 7, the PCB support unit 210, a latching projection 215, the PCB 220, a reflective plate 225, a coupling unit 227, the LED 230, the light transmitting unit 240 and the power supply unit 260 are shown.

Referring also to FIG. 6, the PCB support unit 210, both ends of the PCB support unit 210 have a projecting part to be installed easily. For example, the projecting part can be engaged with the ceiling so that the lamp according to this embodiment can be installed on the ceiling.

In addition, this embodiment can further include the reflective plate 225 that is coupled and positioned on the PCB 220. Namely, the reflective plate 225 prevents the light emitted from the LED 230 from being incident on the PCB 220 and has a reflective material applied thereon. The reflective plate 225 can be coupled to the PCB support unit 210 while being supported by the latching projection 215 that is formed on the PCB support unit 210 to be projected. In addition, each of the PCB support unit 210, the PCB 220 and the reflective plate 225 can be coupled to one another through the coupling unit 227. For example, the coupling unit 227 may be a bolt.

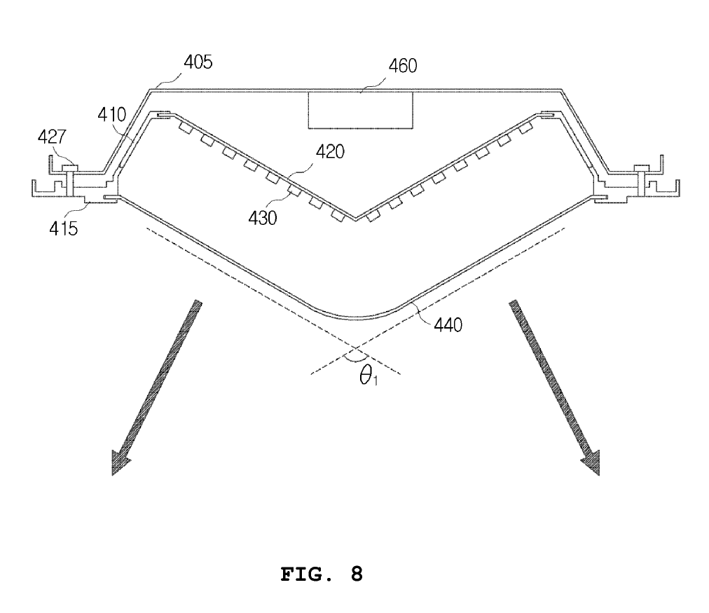

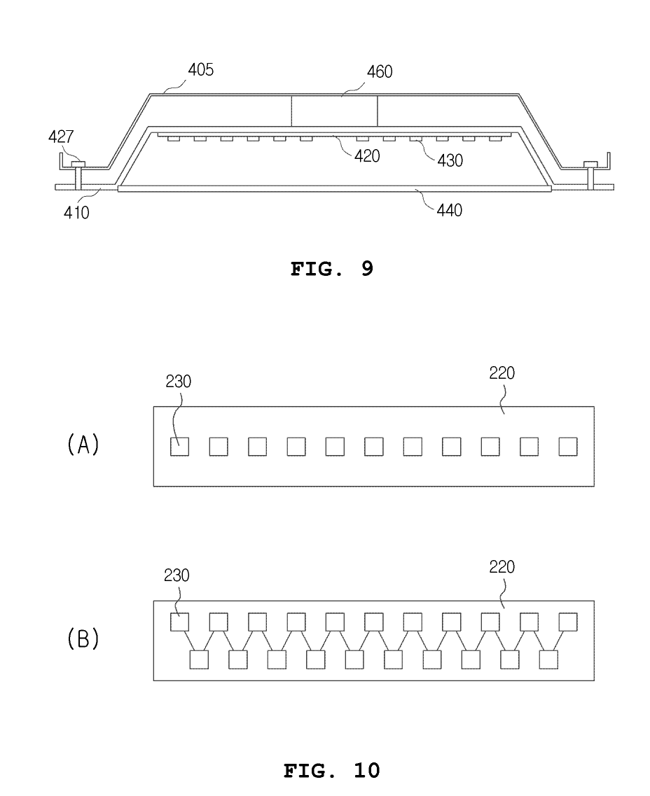

FIGS. 8 and 9 are cross sectional views of an LED lamp having a broad and uniform light distribution according to still another exemplary embodiment of the present invention. Referring to FIGS. 8 and 9, a housing 405, a PCB support unit 410, a skin unit 415, a PCB 420, a coupling unit 427, an LED 430, a light transmitting unit 440 and a power supply unit 460 are shown. The following description will be focused on a difference between this embodiment and the above description.

These embodiments are characterized in that the housing 405 can be detachably coupled to the PCB support unit 410, the PCB 420, the LED 430 and the light transmitting unit 440. In other words, according to this embodiment, an LED module is detachably coupled to the housing 405, which is used as a conventional lamp device for a fluorescent or incandescent lamp, thereby easing the replacement thereof.

Referring to FIG. 8, the PCB 420 and the light transmitting unit 440 are bent to face opposite to each other. The PCB 420 is coupled to be fixed to the PCB support unit 410 and the light transmitting unit 440 is coupled to be fixed to the skin unit 415. The skin unit 415 can have a material or shape such that aesthetic appeal can be created when the skin unit 415 is coupled to a boundary of the housing 405. The PCB support unit 410 and the skin unit 415 can be formed in different materials or can be formed in one body.

The PCB support unit 410 is coupled to the housing 405 through the coupling unit 427 such as a screw, as described above. The coupling unit 427 can be easily manipulated so that, when the LED 430 is dead or needs to be repaired, a user can separate the PCB support unit 410 from the housing 405 to perform an appropriate action.

The housing 405 can be installed in an existing or new structure. For example, depending on the user's choice, only an LED module according to this embodiment can be replaced in the housing 405 of a conventional lamp installed on the ceiling or an entire lamp including the housing 405 can be replaced.

Here, the PCB support unit 410, the skin unit 415, the PCB 420 and the light transmitting unit 440 can be formed in one body. In other words, while the PCB support unit 410, the skin unit 415, the PCB 420 and the light transmitting unit 440 can be assembled as separate units, the PCB support unit 410, the skin unit 415, the PCB 420 and the light transmitting unit 440 can also be formed in one body to be coupled to the housing 405. In addition, the PCB support unit 410, which is a part that is exposed to the outside, can serve as a skin of the lamp and, in this case, the PCB support unit 410 can be formed in a material having various colors and various textures.

Referring to FIG. 9, the PCB support unit 410 is coupled to the housing 405 by the coupling unit 427 while the PCB 420 and the light transmitting unit 440 can be formed parallel to each other instead of being bent. In other words, this embodiment is characterized in that the PCB support unit 410, the non-bent PCB 420, the non-bent PCB 420, the LED 430, and the non-bent light transmitting unit 440 are detachably coupled to the housing 405.

In addition, referring to FIG. 10, a plurality of the LEDs 230, arranged in one row (see (A) of FIG. 10) or in two or more rows (see (B) of FIG. 10), are mounted on one side of the PCB 220. When the LEDs are mounted in two or more rows, the LEDs 230 can be arranged parallel to one another or in a zigzag pattern.

In addition, according to another embodiment, when the PCB 420 is formed to be bent as described above, the plurality of the LEDs 230 mounted on each side can be arranged in the zigzag pattern with respect to the LED 230 mounted on the other side. For example, when the PCB 420 is bent to include a first and a second sides adjacent to each other, the plurality of the LEDs 230 arranged in one row can be mounted on the first side while the plurality of the LEDs 230 can be mounted on the second side being arranged in the zigzag pattern with respect to the LED 230 on the first side, as shown in (B) of FIG. 10. Here, the LEDs 230 arranged in the zigzag pattern can be a set of one or more of the LED 230. In the latter case, the plurality of the LEDs 230 not exceeding ten can form the set and different sets can be arranged in the zigzag pattern. According to this embodiment, it is advantageous in that a uniform light can be radiated outwardly because the plurality of the LEDs 230 are arranged in the zigzag pattern.

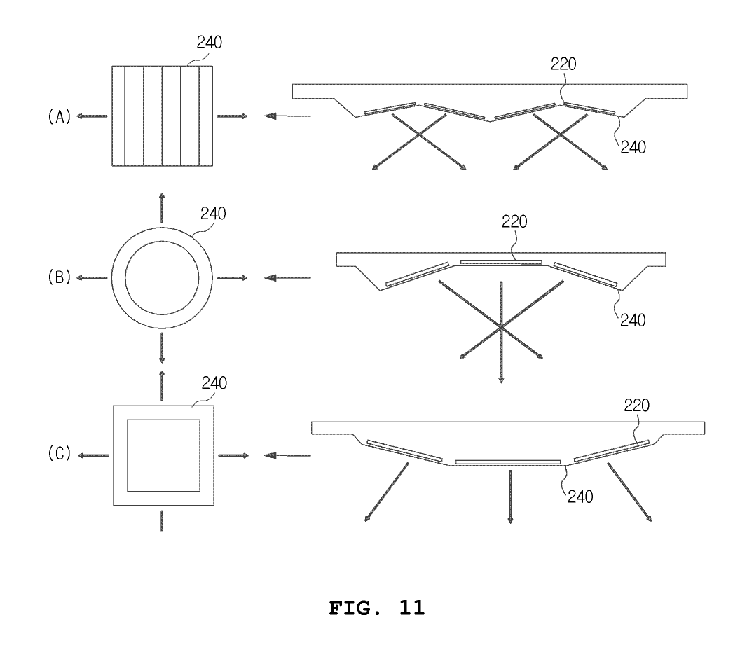

In addition, with reference to FIG. 11, the lamp according to the present embodiment can have a structure in which a light distribution is broad and uniform not only in both left and right directions but also in four directions or in a circular shape (including an elliptical shape). In other words, a bending pattern of the PCB 220 and/or the light transmitting unit 240 can be formed not only in the left and right directions but also in the four directions or in the circular shape. (A) Shows a structure in which a light is diffused in both directions, (B) shows a direction in which a light is diffused in the circular shape, and (C) shows a structure in which a light is diffused in the four directions.

When the lamp according to this embodiment has a circular plane (B), the PCB 220 and/or the light transmitting unit 240 can be formed to be bent in a direction from a center to a circumference thereof. In addition, when the lamp according to this embodiment has a rectangular plane (C), the PCB 220 and/or the light transmitting unit 240 can be formed to be bent in a direction from the center to each edge thereof.

In the above, the cross sectional views generally illustrating the LED lamp having a broad and uniform light distribution are described, and hereinafter, with reference to the accompanying drawings, the LED lamp having a broad and uniform light distribution according to the present invention are described with specific example embodiments. The example embodiments are described in a numerical order and it should be noted that the present invention is not limited to these embodiments.

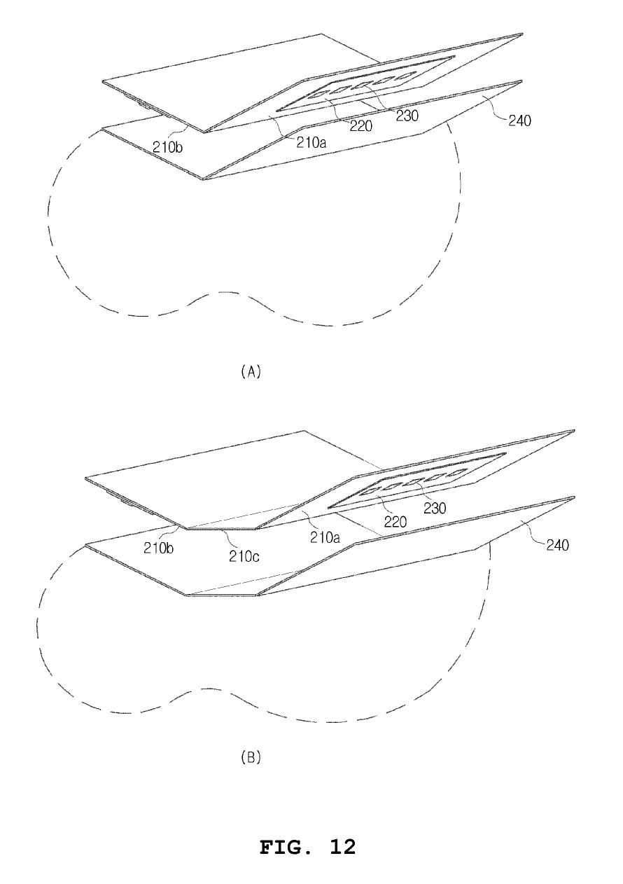

FIGS. 12 through 14 are cross sectional views of an LED lamp having a broad and uniform light distribution according to another exemplary embodiment of the present invention. Referring to FIGS. 12 to 14, various example embodiments are suggested in which, for example, the PCB support unit 210 has multiple sides to which different PCBs 220 are coupled, or the PCB support unit 210 has a cross section in an arc shape and different PCBs 220 are coupled on both sides thereof. A dotted line represents the light distribution curve. Hereinafter, for illustrative purposes, the description will be made with respect to an arrangement and a structure of the PCB support unit 210, the PCB 220, and the LED 230, which are received in the light transmitting unit 240, and the light transmitting unit 240.

Referring to FIG. 12(A), a first PCB support unit 210a and a second PCB support unit 210b are coupled to each other while forming the above described angle therebetween. The LED 230, which is mounted on the PCB 220 that is respectively coupled to the first PCB support unit 210a and the second PCB support unit 210b, is tilted by the above described angle to radiate a light, and therefore, the LED lamp according to this embodiment forms a broad light distribution.

Referring to FIG. 12(B), the first PCB support unit 210a, a third PCB support portion 210c, and the second PCB support unit 210b are subsequently connected to one another. The PCB 220 and the LED 230 are coupled to the first PCB support unit 210a and the second PCB support unit 210b to radiate a more intense light on both sides. In addition, the PCB 220 and the LED 230 can also be coupled to the third PCB support unit 210c. In this case, in order to form an overall broad and uniform light distribution, a brightness of the LED 230, which is coupled to the first PCB support unit 210a, the third PCB support unit 210c, and the second PCB support unit 210b, can be controlled.

For example, the light distribution can be formed to be broad and uniform by controlling a brightness of the LED 230 coupled to the first PCB support unit 210a and the second PCB support unit 210b to be greater than a brightness of the LED 230 coupled to the third PCB support unit 210c. In other words, when the PCB 220 has three or more sides, a brightness of the LED 230 mounted on the PCB 220 that is positioned in both lateral directions can be greater than a brightness of the LED 230 mounted on the PCB 220 that is positioned in a frontal direction. Here, the brightness of the LED 230 can be controlled by controlling an input current or the number of the LEDs 230.

In addition, the brightness of the LED 230 can be controlled corresponding to a cross section of the light transmitting unit 240. In other words, when the PCB 220 includes three or more sides and the cross section of the light transmitting unit 240 faces opposite to the PCB 220, a brightness of the LED 230 that is mounted on the side of the PCB 220 facing opposite to a lateral side of the cross section of the light transmitting unit 240 can be greater than a brightness of the LED 230 mounted on the side of the PCB 220 facing opposite to a front side of the cross section of the light transmitting unit 240.

In addition, when the light transmitting unit 240 has a cross section in a trapezoidal shape, a pattern can be formed on a bottom side of the trapezoid or a the bottom side of the trapezoid can be formed to be translucent or opaque, thereby reducing a light distribution toward an immediate downward direction, while forming a slanted light distribution on both directions through both sides of the trapezoid to form an overall broad and uniform light distribution of the LED lamp.

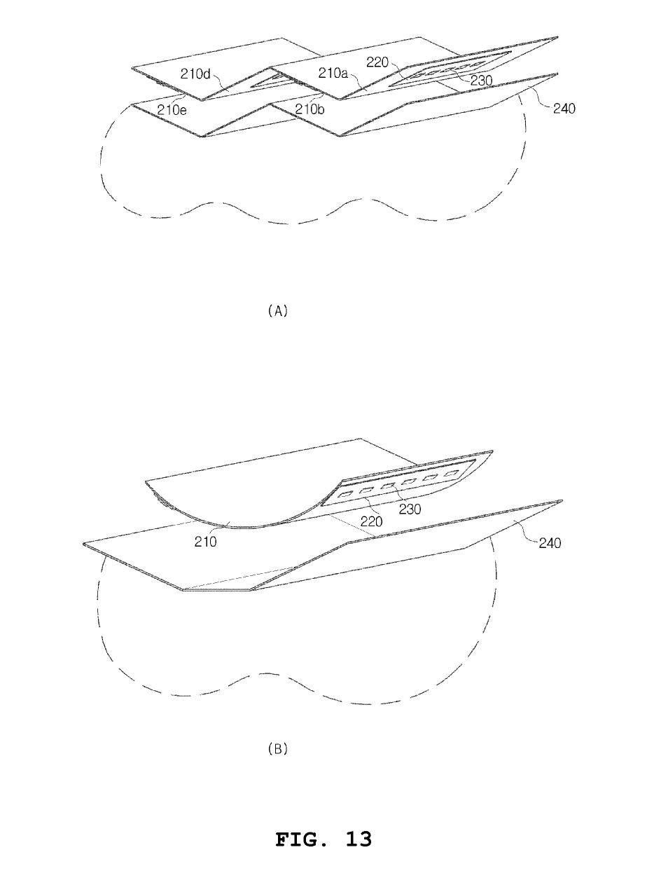

Referring to FIG. 13(A), the first PCB support unit 210a, the second PCB support unit 210b, a fourth PCB support unit 210d and a fifth PCB support unit 210e are subsequently connected to one another. An angle formed between each PCB support unit can be the same or different from each other. For example, when an angle between the first PCB support unit 210a and the second PCB support unit 210b is less than an angle formed between the third PCB support unit 210c and the fourth PCB support unit 210d, the LED 230 coupled to the first PCB support unit 210a is tilted in a lateral direction of the drawing to emit a light, so that the LED lamp according to this embodiment can have a broad and uniform light distribution. Therefore, according to this embodiment, by controlling the angle formed between the first PCB support unit 210a and the second PCB support unit 210b and the angle formed between the third PCB support unit 210c and the fourth PCB support unit 210d, relatively to each other, an overall light distribution curve can be adjusted.

Referring to FIG. 13(B), the LED lamp in which the PCB support unit 210 is bent in an arc shape and different PCBs 220 are coupled to both sides of the PCB support unit 210 is illustrated. Here, the arc shape includes various bent shapes such as, for example, a circle, an ellipse, or a curve. According to this embodiment, it is advantageous in that the LED lamp according to this embodiment can be easily manufactured by using a simple process of bending the PCB support unit 210.

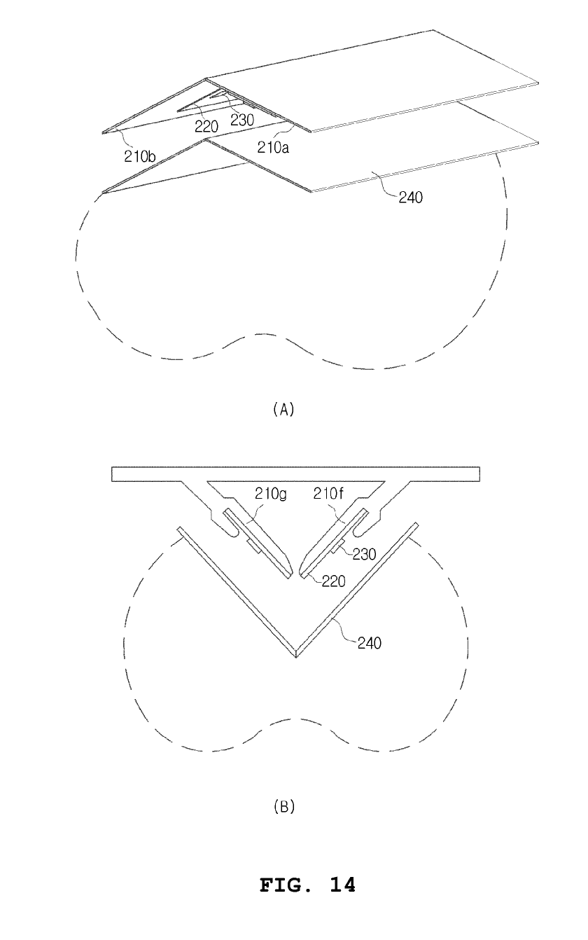

Referring to FIG. 14(A), the first PCB support unit 210a and the second PCB support unit 210b are formed to be bent in a direction opposite to the above description. Therefore, the LED 230 coupled to the PCB support unit 210a emits a light in a left direction of FIG. 14(A) and the LED 230 coupled to the PCB support unit 210b emits a light in a right direction of FIG. 14(B), which has an effect to broaden the light distribution.

Here, a smaller angle formed between sides of multiple PCBs 220 (for example, angle between sides on which the LED 230 is mounted) can be 45 degrees to 180 degrees, as described above, and the light emitted from the LED 230 at this angle is radiated toward a lateral side of the LED lamp, thereby forming a broad and uniform light distribution.

Referring to FIG. 14(B), the PCB support unit 210 is equipped with a predetermined structure, for example, multiple support arms, to support the PCB 220. The PCB support unit 210 is formed in the multiple support arms, which are spaced apart from each other to be projected. For example, the PCB support unit 210 can include a body (i.e., an upper support), a first support arm 210f that is formed to be projected from the body in one direction to support the PCB 220, and a second support arm 210g that is formed to be projected from the body in the other direction to support the PCB 220. The first support arm 210f and the second support arm 210g can be formed to be integrally continuous in a direction in which the light transmitting unit 240 is extended or can be formed to be partially projected, thereby being capable of supporting the PCB 220. The first support arm 210f and the second support arm 210g can support the PCB 220 by holding a particular portion of the PCB 220 (e.g., attachment, screw coupling, etc.) or by inserting the entire PCB 220 therein.

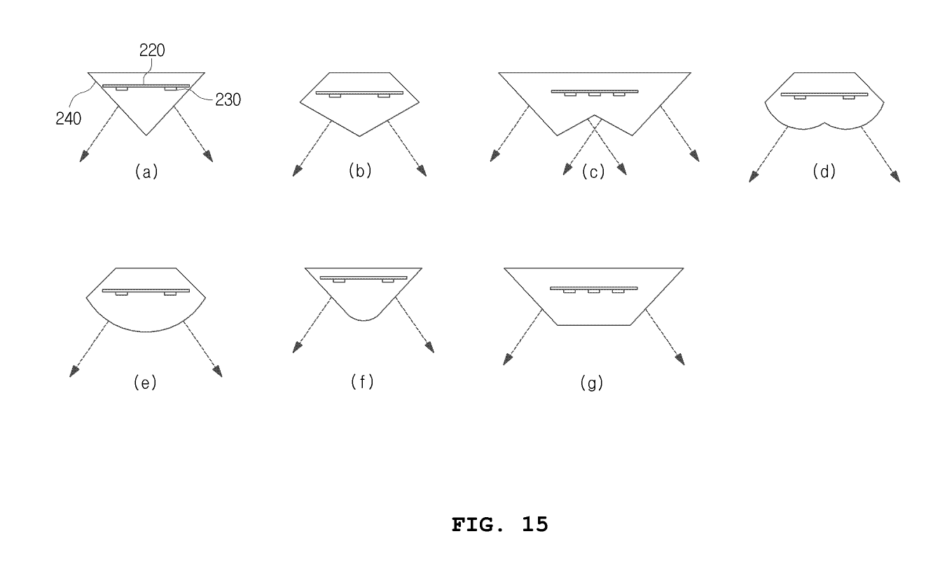

FIGS. 15 through 17 are cross sectional views schematically illustrating various LED lamps having a broad and uniform light distribution according to another exemplary embodiment of the present invention. For illustrative purposes, only the PCB 220, the LED 230, and the light transmitting unit 240 are illustrated for explaining the cross section of the LED lamp according to this embodiment. A dotted line represents a direction of progress of a light, which forms a major light distribution.

Referring to FIG. 15, the PCB 220 is a flat plane and the cross section of the light transmitting unit 240 has a predetermined angle, thereby significantly increasing intensity of a lateral side light. A lateral side of cross section of the light transmitting unit 240 is formed slanted relative to the PCB 220. In addition, the cross section of the light transmitting unit 240 can be a triangle, a trapezoid, or a polygon including a pentagon (a, b, c, g). Also, one side of the light transmitting unit 240 can be an arc.

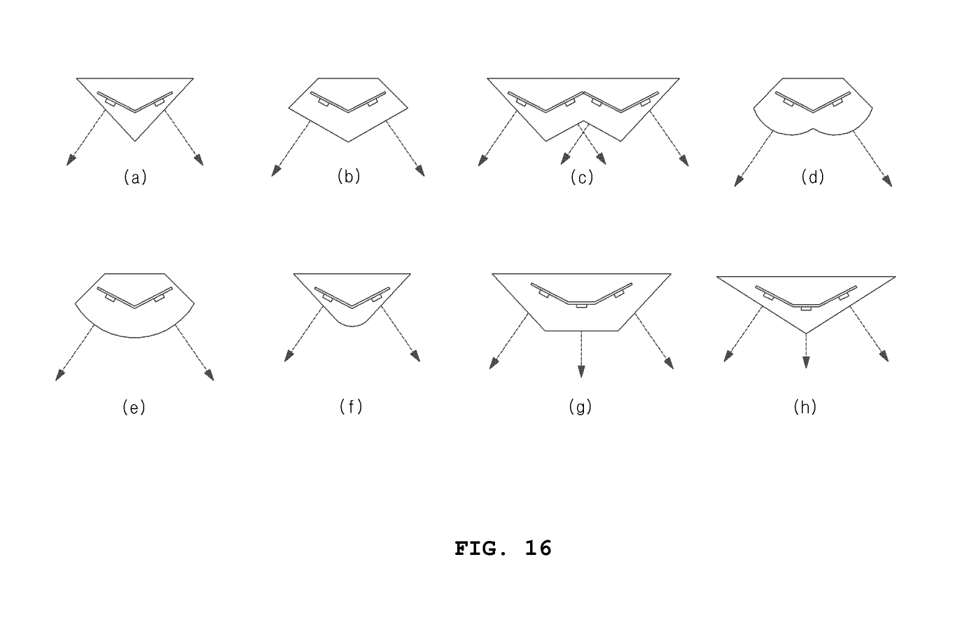

Referring to FIG. 16, each PCB 220 is externally oriented to face outwardly, and the cross section of the light transmitting unit 240 can have various shapes. To provide a more specific classification, the cross section of the light transmitting unit 240 can be formed to face opposite to the PCB 220 as described above (a through h). In addition, the cross section of the light transmitting unit 240 can be a triangle, a trapezoide, a rectangle, and a polygon including a pentagon (a, b, c, g, h). Also, one side of the light transmitting unit 240 can be an arc (d, e, f). Here, when the one side of the light transmitting unit 240 is the arc, the whole or part of the cross section of the light transmitting unit 240 can be the arc. Here, when the PCB 220 or the light transmitting unit 240 is bent as shown herein, the number of a bent portion can be in a range of 1 to 4.

Referring to FIG. 17, each PCB 220 is internally oriented to face inwardly, and the cross section of the light transmitting unit 240 can have various shapes. Specifically, a lateral side of the cross section of the light transmitting unit 240 can be formed to face opposite to the PCB 220 (a through h). In addition, the cross section of the light transmitting unit 240 can be a triangle, a trapezoide, a rectangle, and a polygon including a pentagon (a, b, c, g, h), and one side of the light transmitting unit 240 can be the arc, as described above.

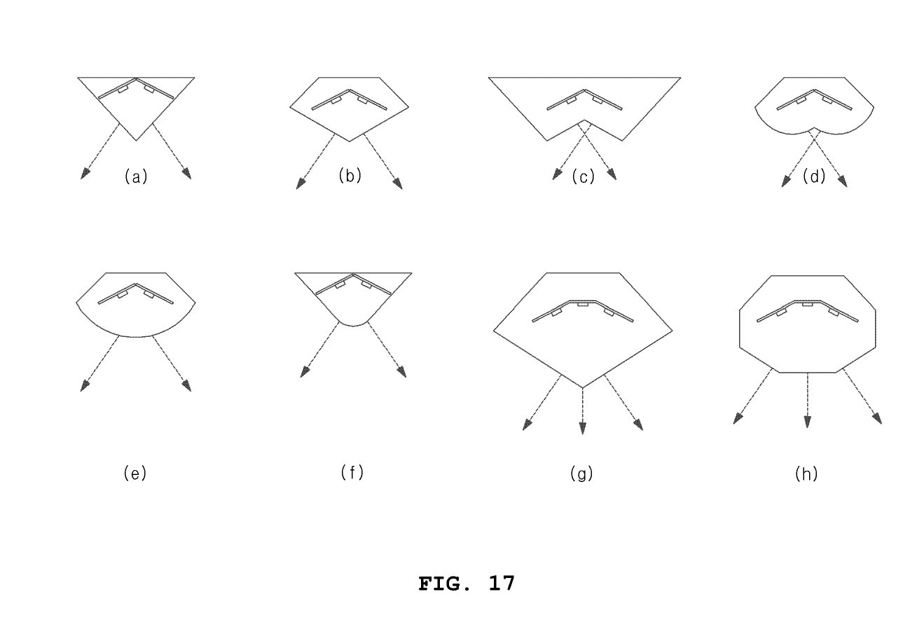

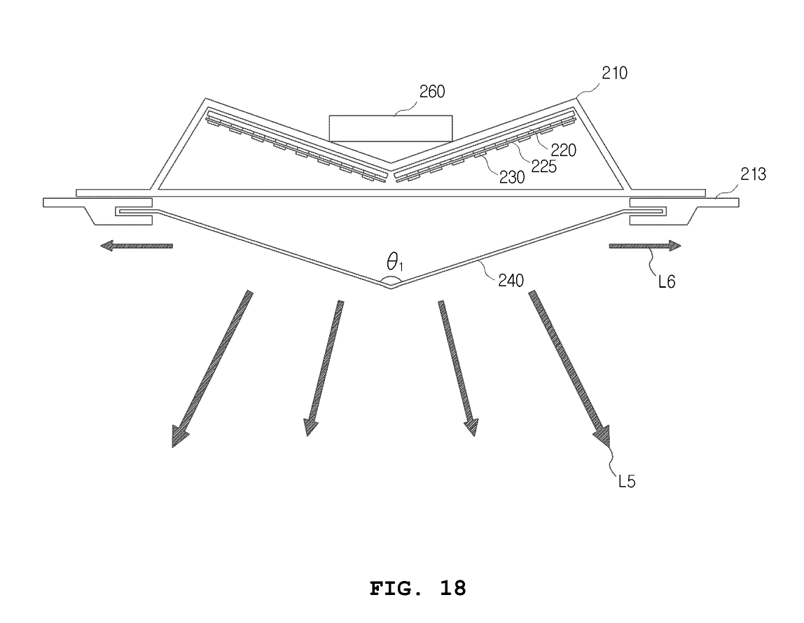

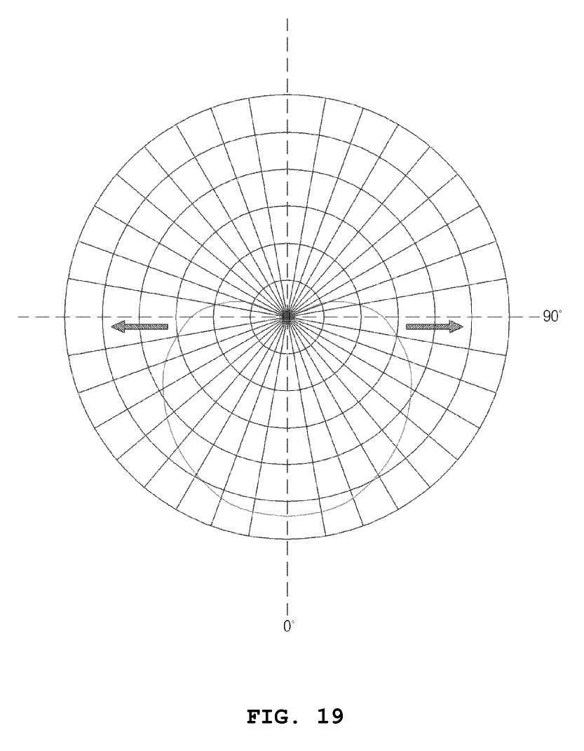

FIG. 18 is a cross sectional view illustrating an LED lamp having a broad and uniform light distribution according to an exemplary embodiment of the present invention, and FIG. 19 is a view illustrating a light distribution curve of the LED lamp shown in FIG. 18. Referring to FIG. 18, the PCB support unit 210, the light transmitting unit holder 213, the PCB 220, the reflective plate 225, the LED 230, the light transmitting unit 240, and the power supply unit 260 are shown. The following description will be focused on a difference between this embodiment and the above description.

This embodiment is characterized in that the PCB 220 and the light transmitting unit 240 are formed to be tilted to oppose each other. The LED lamp according to this embodiment is characterized in that a light distribution is wide and uniform by attaching, bending or curving the PCB 220 and the light transmitting unit 240 for transmitting a light to form a predetermined angle relative to a downward vertical axis, wherein the PCB 220 and the light transmitting unit 240 are provided in an interior of the LED lamp to replace a conventional lamp device that uses a fluorescent lamp or an incandescent lamp.

A most desirable light distribution curve includes, at first, a butterfly-shaped light distribution curve in which intensity of a light is highest at 20 degrees to 40 degrees, similarly to a conventional fluorescent lamp, so that a surface that receives the light is evenly bright without any shadow, and secondly, in case of a flat type LED lamp where a light source is not a line light source or the point light source, a luminous quantity does not need to be dramatically decreased at an angle equal to or greater than 30 degrees, and thus, a light distribution curve in which the luminous quantity is rather higher enough to illuminate a ceiling adjacent to the lamp device at about 80 degrees to about 90 degrees, i.e., a light distribution created in consideration of an illumination space instead of an illumination surface is the most desirable. This embodiment is a technology primarily focused on implementing the latter feature.

This embodiment can further include the reflective plate 225 that is coupled to the PCB 220. The reflective plate 225 prevents the light emitted from the LED 230 from being incident on the LED 230 and a reflective material is applied thereto.

The LED lamp having the above described structure has the light distribution curve shown in FIG. 19. Referring to FIG. 19 in comparison with FIG. 3, the light distribution curve has a shape of a wide lateral spread, and thus, a broad and uniform light distribution curve is achieved. In other words, the light distribution curve according to this embodiment is widely distributed because the light from the LED 203 has high intensity toward a lateral side (for example, a 90-degree direction).

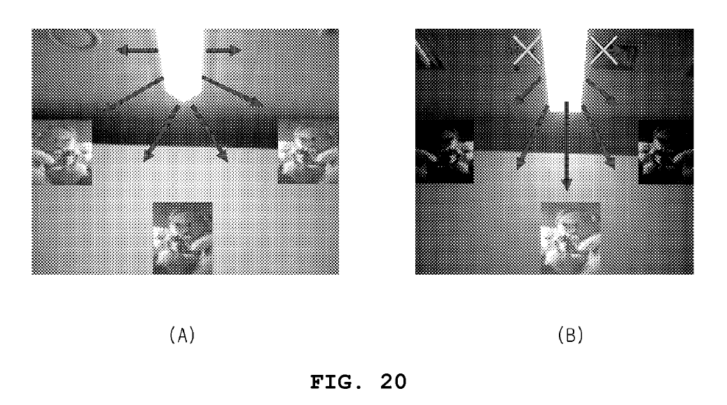

FIG. 20 is a view showing comparison between example experiments of the LED lamp of FIG. 18. (A) shows the LED lamp according to the present embodiment being illuminated and (B) shows a prior art lamp device being illuminated. Based on comparison of the two views, the LED lamp according to this embodiment has advantages in that both the PCB 220 and the light transmitting unit 240 are tilted to oppose each other so that the intensity of the lateral side light is high, thereby achieving a broad and uniform light distribution.

FIG. 21 is a cross sectional view illustrating an LED lamp having a broad and uniform light distribution according to another exemplary embodiment of the present invention. Referring to FIG. 21, the PCB support unit 210, the PCB 220, the LED 230, the light transmitting unit 240, and the power supply unit 260 are shown. The following description will be focused on a difference between this embodiment and the above description.

Referring to FIG. 21, the PCBs 220 are largely divided into three categories. In other words, the PCB 220s are positioned on a center portion, a left portion, and a right portion, and the PCB 220 placed on the right portion and the PCB 220 placed on the left portion are tilted in different directions, thereby having different directions of a major light distribution thereof. Thus, according to such structure, this embodiment has a broad and uniform light distribution.

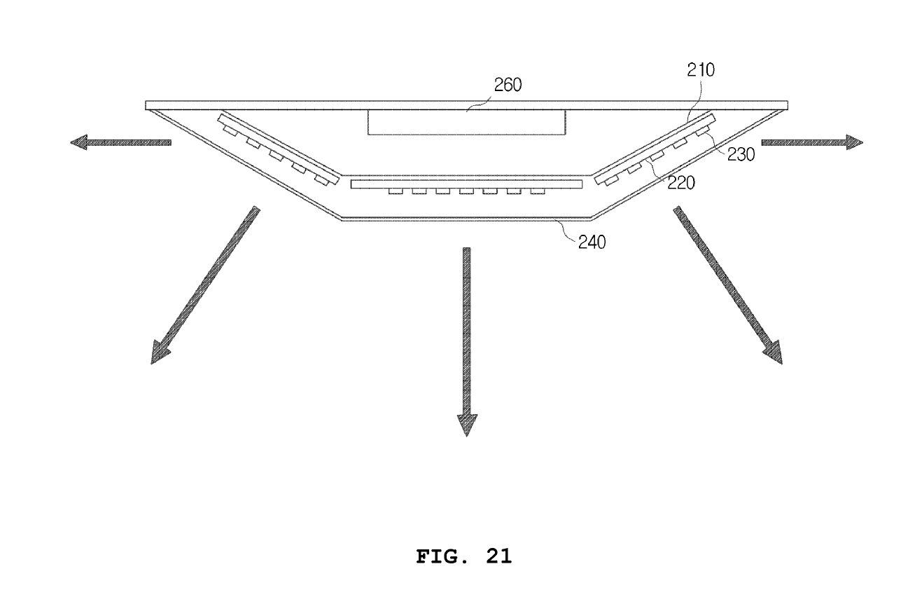

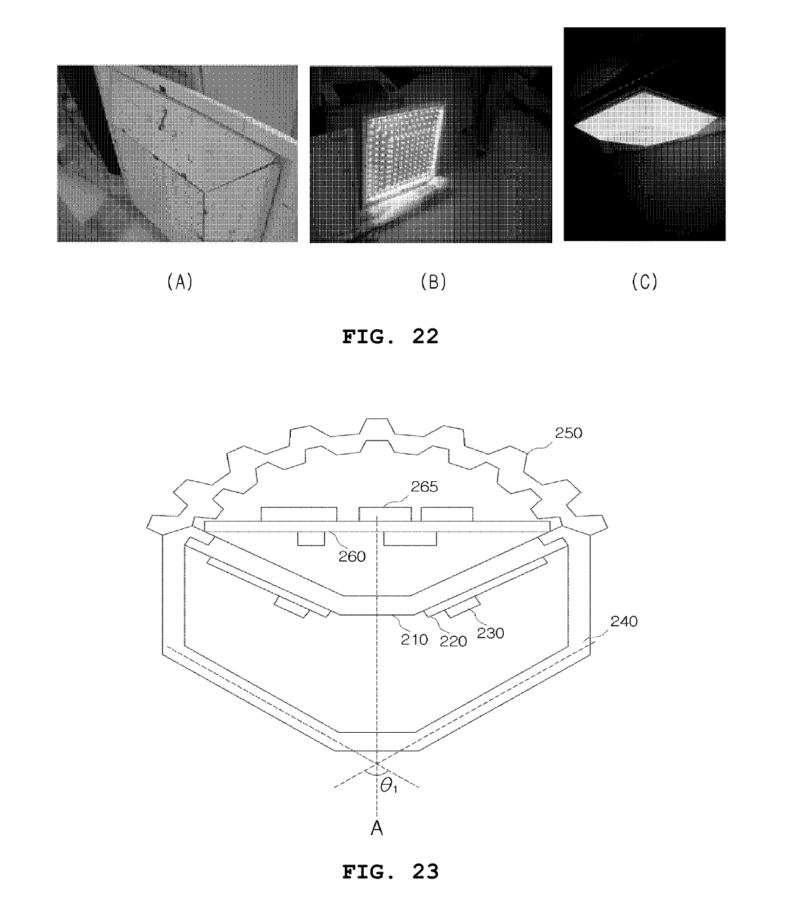

FIG. 22 shows an exemplary embodiment of the LED lamp shown in FIG. 21. (A) shows a perspective view of the LED lamp while the light transmitting unit 240 is not attached thereto, (B) shows the LED 230 that is turned on in the LED lamp shown in (A), and (C) shows the LED lamp that is turned on while the light transmitting unit 240 is attached thereto.

According to this embodiment, in order to provide a wide and uniform light distribution as described above, the PCB 220 includes multiple bent portions (i.e., the PCB 220 is bent multiple times) while, at the same time, the LEDs 230 are arranged in the zigzag pattern so that a point defect of the LED 230 may not be shown to the outside, and thus, it is advantageous in that a heat generated in the LED 230 is naturally distributed due to the bent portion of the PCB 220 and the arrangement of the LED 230 in the zigzag pattern, and a heat release characteristic is enhanced through the PCB support unit 210, which is formed in a wide metal.

FIGS. 23 through 25 are various cross sectional views of the LED lamp having a broad and uniform light distribution according to an exemplary embodiment of the present invention. The PCB support unit 210, the PCB 220, the LED 230, the light transmitting unit 240, a radiator 250, a PSU board 260 and a PSU part 265 are shown. The drawings will be described in a numerical order below and the following description will be focused on a difference between this embodiment with the above description.

The LED lamp according to this embodiment is characterized in that the LED lamp is formed in the tube type similar to the conventional fluorescent lamp while the PCB 220, which is provided in an interior thereof, is attached, bent or curved to form a predetermined angle, thereby achieving a broad and uniform light distribution. Namely, the LED lamp according to this embodiment is provided with the PCB 220 that has a predetermined angle so that the LED 230 can radiate a light in a different direction, thereby achieving a broad light distribution. The LED lamp according to this embodiment can be a bulb that is coupled with the LED lamp device in an attachable and/or detachable manner. This embodiment can apply in a case where the PCB 220 is implemented as a flat plane and the light transmitting unit 240 is bent; however, the following description will be made with respect to a case where the PCB is bent.

Referring to FIG. 23, the PCB support unit 210 is a frame that supports the PCB 220 and each side of the PCB support unit 210 on which the PCB 220 is provided can form the above-described predetermined angle so that the PCB 220 can have the predetermined angle and be supported. The PCB 220 can include multiple PCBs that are individually coupled to each side of the PCB support unit 210 or one PCB that is bent corresponding to a surface of the PCB support unit 210. Hereinafter, the description will be made with respect to the former case. In addition, the PCB 220 that is applied to this embodiment may be rigid or flexible.

Here, the angle formed by the PCB 220 can be 45 degrees to 180 degrees. In other words, a smaller angle formed by the sides of multiple PCBs 220 (for example, angle between rear sides on which the LED 230 is mounted) can be 45 degrees to 180 degrees. Due to the angle formed by the sides of the PCB 220, a light emitted from the LED 230 can be radiated toward a lateral side of the LED lamp to form a broad and uniform light distribution.

The light transmitting unit 240 can be extended in one direction to be formed in a shape of a tube. The light transmitting unit 240 is an area in which the light emitted from the LED 230 passes therethrough and is radiated toward the outside, and therefore, the light transmitting unit 240 can include the diffusion element for diffusing the light, as described above.

In addition, the light transmitting unit 240 can be symmetric relative to a virtual surface that divides the LED lamp according to the present embodiment in half. Two sides of the light transmitting unit 240 are disposed symmetrically to each other with respect to line A that is the cross section of the virtual surface.

The PCB support unit 210 can be extended in a corresponding direction to form a predetermined angle with respect to an axis of one direction in which the light transmitting unit 240 is extended so that the PCB 220 can form a predetermined angle.

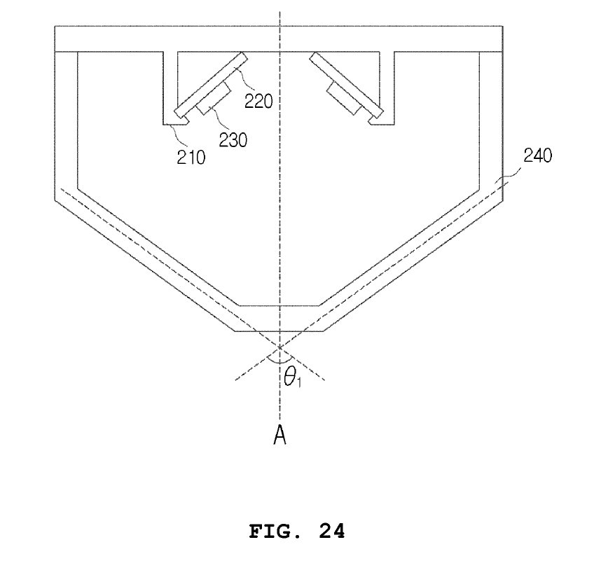

Referring to FIG. 24, the PCB support unit 210 can support the PCB 220 by using a predetermined structure to support the PCB 220. Various forms of the PCB support unit 210 can be applicable to the present invention as long as the PCB support unit 210 supports the PCB 220. For example, the PCB support unit 210 has a projection part (also can be referred to as a support arm) on both sides thereof to support the respective PCB 220. In this case, differently from the above-described FIG. 23, the PCB 220 can be formed such that sides on which the LED 230 is mounted face opposite to each other and the light emitted from the LED 230 can be crossed to each other.

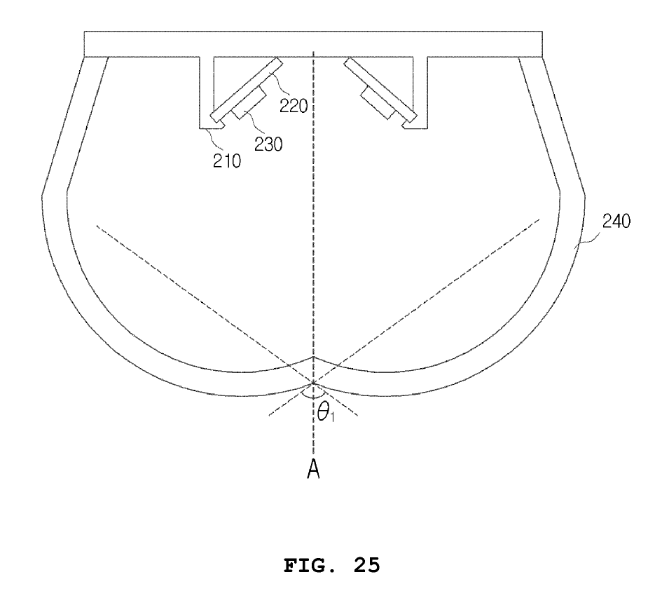

Referring to FIG. 25, the light transmitting unit 240 is shown in which a lateral side of a cross section thereof has a concave arc shape in a portion facing toward the PCB support unit 210 equipped with the support arm and the PCB 220. The light emitted from the PCB 220 can also be vertically incident on the arc-shaped light transmitting unit 240, as described above, so that an effect of increasing the light distribution toward the lateral side can be achieved.

The radiator 250 can be coupled to the PCB support unit 210 and/or the light transmitting unit 240 to receive heat generated in the LED 230 and release the received heat to the outside. To this end, the radiator 250 can be implemented in various radiation structures such as, for example, including a plurality of radiator pins. For example, the cross section of the radiator 250 can have a shape of a curve, a straight line, or a combination thereof.

The radiator 250 can be formed integrally with the PCB support unit 210 or can be provided as a separate unit. In the latter case, the radiator 250 can be coupled to the PCB support unit 210 and the light transmitting unit 240 in a predetermined coupling manner, for example, a screw-coupling manner.

According to this embodiment, the LED lamp can be a straight line type that is extended in a predetermined direction (bar type), an annular type (circular or curve shaped), or a U-shaped type. In other words, the LED lamp can be extended in a straight line direction or can be extended in a curved direction to be attached or detached to/from, for example, a lamp. Here, the LED lamp according to this embodiment can further include a power socket 270 which is coupled to both sides of the light transmitting unit 240, wherein an external power is applied thereto.

FIG. 26 is an exploded perspective view illustrating an LED lamp a having broad and uniform light distribution according to an exemplary embodiment of the present invention. Referring to FIG. 26, the PCB 220, the LED 230, the light transmitting unit 240, the radiator 250, and the power socket 270 are shown.

The light transmitting unit 240 is shaped to extend in a predetermined direction and can have various shapes including a bar type, a circular type, or a shape in which the light transmitting unit 210 has a bent portion and both ends thereof are extended in the same direction. The power socket 270 is a terminal that is coupled to both ends or one side of the LED lamp according to this embodiment, wherein the external power is applied to the power socket 270 to provide a current to the LED 230. The cross section of the light transmitting unit 240 corresponds to the drawing of FIG. 23 and the lateral side thereof can oppose the PCB 220.

In addition, as mentioned above, when the PCB 220 is formed to be bent as described above, a plurality of the LEDs 230 mounted on each side of the PCB 220 can be arranged in the zigzag pattern with respect to the LED 230s formed on the other side of the PCB 220. For example, when the PCB 220 is bent to include a first side and a second side that are adjacent to each other, the plurality of the LEDs 230 can be mounted on the first side in a mw while the plurality of the LEDs 230 can be mounted on the second side in the zigzag pattern with respect to the LEDs 230 mounted on the first side.

The radiator 250 is cupled to the light transmitting unit 240 to radiate the heat generated in the PCB 220 toward the outside. The radiator 250 can be extended along a direction in which the light transmitting unit 240 is extended, thereby effectively radiating the heat of the PCB 220.

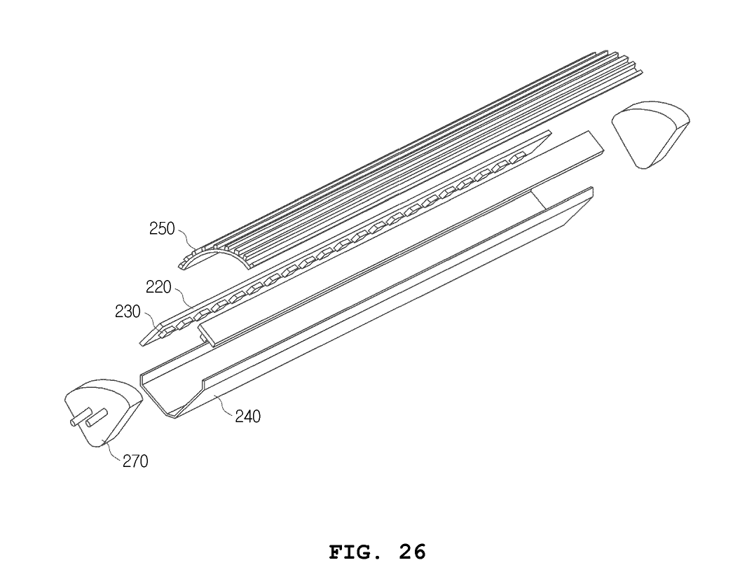

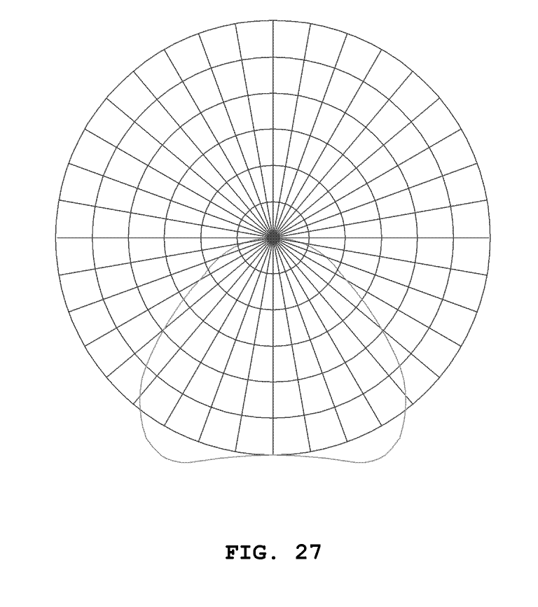

FIG. 27 is a view illustrating a light distribution curve of the LED lamp FIG. 26 having the broad and uniform light distribution. Referring to FIG. 27, the light distribution curve has a shape of being spread toward a lateral side thereof, thereby yielding a broad and uniform light distribution curve.

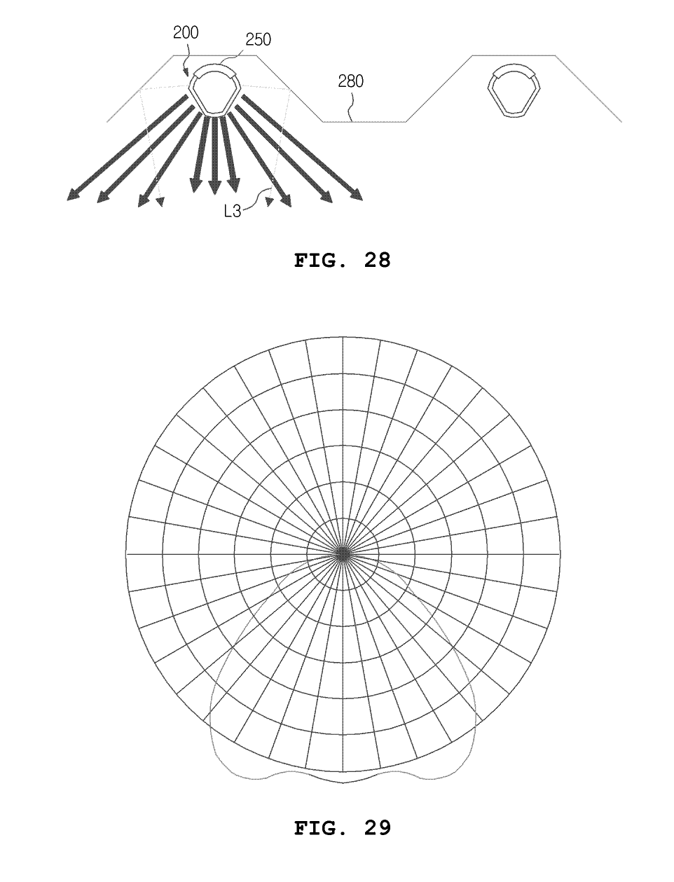

FIG. 28 is a cross sectional view of an LED lamp according to an exemplary embodiment mounted within a lamp device frame, and FIG. 29 is a view illustrating a light distribution curve of the lamp device frame equipped with the LED lamp shown in FIG. 28.

The lamp device frame 280 is formed in a reflective material or the reflective material is applied to an inner surface of the lamp device frame 280 so that a path of the lateral light from the LED lamp 200, which does not progress in a downward direction, is changed to progress in the downward direction.

In this case, the lamp device frame 280 enables a side light L3, which was not capable of contributing to the brightness in a downward direction when employing only the LED lamp 200, can now contribute to the brightness in the downward direction. Therefore, as shown in FIG. 29, more uniform and better light distribution can be achieved on a surface where a light is incident.

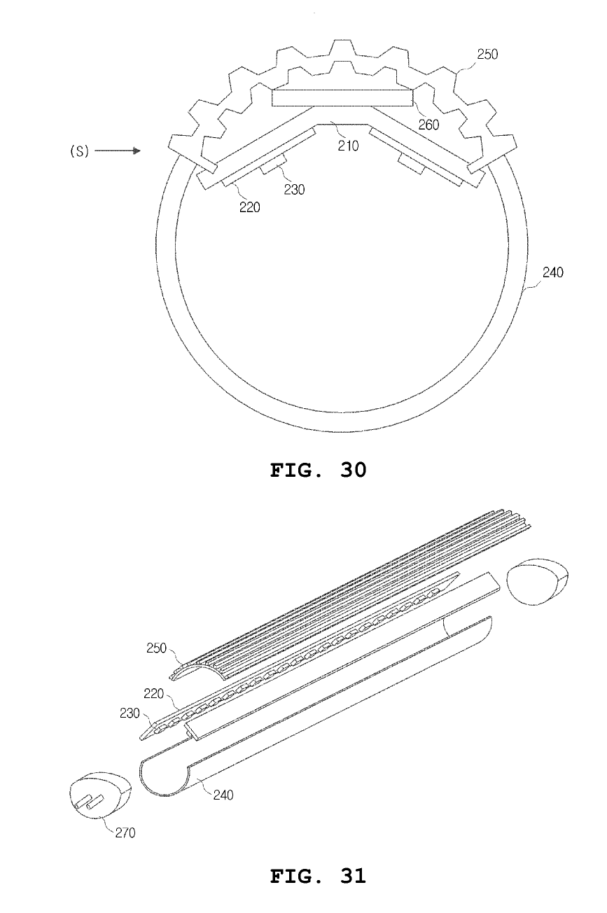

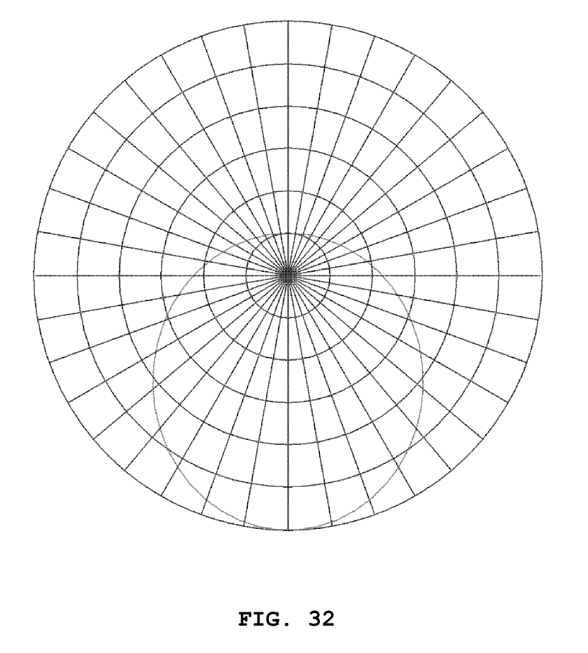

FIG. 30 is a cross sectional view illustrating an LED lamp having a broad and uniform light distribution according to still another exemplary embodiment of the present invention, FIG. 31 is an exploded perspective view of the LED lamp of FIG. 30, and FIG. 32 is a view illustrating a light distribution curve of the LED lamp of FIG. 30. The following description will be focused on a difference between this embodiment and the above description.

Referring to FIGS. 30 and 31, the light transmitting unit 240 of which entire cross section is an arc shape is shown. In such a shape, the light transmitting unit 240 is concave with respect to the PCB 220 so that the lateral side light is increased to broaden the light distribution, as described above. When compared with a prior art, the light distribution curve of FIG. 32 has an increased lateral side light, thereby achieving an effect to have a broad and uniform light distribution.

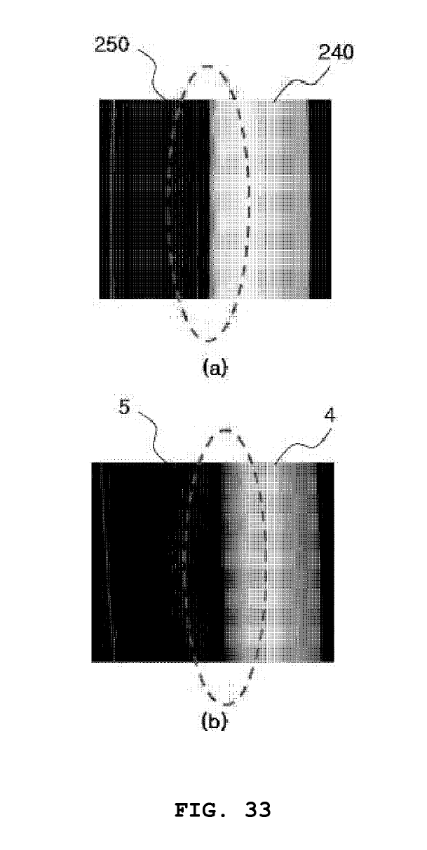

FIG. 33 is a view showing comparison of a photograph of a lateral side light of the LED lamp of FIG. 30 and a photograph of a side light of a conventional LED lamp. (a) of FIG. 33 shows a lateral side light seen from a direction (S) in FIG. 30 and (b) of FIG. 33 shows, in correspondence with (a), a lateral side light directed between the light transmitting unit 4 and the radiator 5 according to the prior art. Each lateral side light is a light projected from the light transmitting unit 4, 240 that is adjacent to the radiator 5, 250. A boundary between the radiator 5, 250 and the light transmitting unit 4, 240 are represented in a dotted line.

Referring to FIG. 33, while a point defect in accordance with an interval between the LEDs is shown in (b) and an intensity of the lateral side light is lower, the point defect in accordance with an interval between the LEDs is not shown in (a), resulting in a uniform lateral side light, and the intensity of the lateral side light is higher, thereby being advantageous with respect to a light distribution thereof. In other words, the lateral side light in (a) is brighter and clearer than the lateral side light in (b), which means that the lateral side light of the LED lamp according to this embodiment has a higher intensity and a wider light distribution curve.

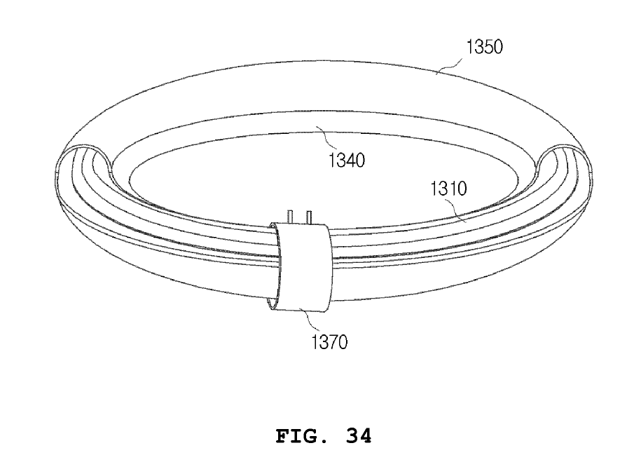

FIG. 34 is a perspective view of an LED lamp according to still another exemplary embodiment of the present invention. Referring to FIG. 34, an LED lamp in a circular tube shape including a PCB support unit 1310, a light transmitting unit 1340, a radiator 1350, and a connection unit 1370 is shown. The PCB support unit 1310 is formed to have various cross sections as described above and is extended or arranged in a direction in which the light transmitting unit 1340 is extended, and thus replaces a circular shaped fluorescent lamp to implement an LED lamp having a broad and uniform light distribution. The connection unit 1370 is an element that is a source of a current supplied to the LED, to which the external power is applied.

### INDUSTRIAL APPLICABILITY

It should be understood by those skilled in the art that various changes in form and details may be made therein without departing from the spirit and scope of the present invention as defined by the appended claims.

1. A light emitting diode (LED) lamp having a broad and uniform light distribution, the LED lamp comprising:
a printed circuit board (PCB) on which a plurality of LEDs for emitting a light are mounted;
a light transmitting unit configured to face opposite to a side of the PCB on which the LED is mounted and configured to form a predetermined angle such that a light emitted from the LED is diffused in a different direction of a major light distribution corresponding to the predetermined angle;
a PCB support unit configured to support the PCB; and
a power supply unit configured to supply a power to the LED.

2. The LED lamp according to claim 1, wherein an angle formed between lateral sides of a cross section of the light emitting unit is 45 degrees to 175 degrees.

3. The LED lamp according to claim 1, wherein the PCB forms a predetermined angle such that the LEDs emit a light in different directions and a smaller angle formed by the PCB is 45 degrees to 180 degrees.

4. The LED lamp according to claim 3, wherein the plurality of the LEDs mounted on different sides of the PCB are arranged in a zigzag pattern with respect to each other.

5. The LED lamp according to claim 3, wherein the PCB support unit forms a predetermined angle such that the PCB support unit is parallel to the PCB.

6. The LED lamp according to claim 5, wherein the power supply unit is positioned on a groove formed by bending the PCB support unit.

7-13. (canceled)

14. The LED lamp according to claim 1, wherein the light transmitting unit comprises a polymer material or glass.

15. The LED lamp according to claim 14, wherein at least one of one side and the other side of the light transmitting unit has a roughness.

16. The LED lamp according to claim 14, wherein the light transmitting unit further comprises a diffusion element for diffusing the light emitted from the LED.

17. The LED lamp according to claim 1, wherein the light transmitting unit further comprises at least one diffusion sheet coupled to at least one of one side and the other side of the light transmitting unit.

18. The LED lamp according to claim 14, wherein the light transmitting unit comprises:
a base surface comprising a polymer material or glass, wherein a pattern is formed on at least one of one side and the other side thereof to induce diffusion of the light emitted from the LED; and
at least one diffusion sheet coupled to the at least one of the one side and the other side of the base surface.

19. The LED lamp according to claim 14, wherein the light transmitting unit further comprises a prism sheet coupled to the at least one of one side and the other side of the light transmitting unit.

20. The LED lamp according to claim 1, wherein the light transmitting unit has a transmission of 30% to 88%.

21. The LED lamp according to claim 1, wherein the light transmitting unit has a haze of 42% to 99.8%.

22. The LED lamp according to claim 1, wherein an interval between adjacent LEDs among the plurality of the LEDs can be 1 mm to 125 mm.

23. (canceled)

24. The LED lamp according to claim 1, wherein the LED has a diameter of 2 mm to 25 mm.

25. The LED lamp according to claim 1, wherein the light transmitting unit is formed in a diffusion plate that includes a diffusion element, in an interior thereof, for diffusing the light emitted from the LED.

26. The LED lamp according to claim 25, wherein the diffusion element is formed in an oxide series or in a foam-type diffusion structure including a foam-type microcell.

27. The LED lamp according to claim 3, wherein a normal line formed by sides of the PCB and the light transmitting unit, each facing opposite to each other, has an angle of 0 to 45 degrees.

28. The LED lamp according to claim 1, wherein an interval between the LED and the light transmitting unit is 5 mm to 150 mm.

29-30. (canceled)
